(19) United States
(12) Patent Application Publication
(10) Pub. No.: US 2007/0201530 A1
(43) Pub. Date: Aug. 30, 2007

(54) OPTICAL ACTIVE DEVICE AND OPTICAL MODULE USING THE SAME

(76) Inventors: Do-Young Rhee, Yongin-si (KR); Jeong-Seok Lee, Anyang-si (KR); In-Kuk Yun, Suwon-si (KR)

Correspondence Address: CHA & REITER, LLC, 210 ROUTE 4 EAST STE 103, PARAMUS, NJ, 07652, US

(21) Appl. No.: 11/623,807

(22) Filed: Jan. 17, 2007

(30) Foreign Application Priority Data
Feb. 27, 2006 (KR) 2006-18760

(51) Int. Cl. H01S 3/06; H01S 3/097; H01S 3/08

(52) U.S. Cl. 372/92; 372/66; 372/87

(57) ABSTRACT

Provided are an optical active device and optical module using the same The optical active device includes first face through which light received emitted, second face facing the first face third face adjacent the first face and the second face, and fourth face facing the third face which width between the first face and the second face equal greater than distance between the third face and the fourth face

### CLAIM OF PRIORITY

This application claims priority under 35 U.S.C. §119 to an application entitled “Optical Active Device and Optical Module Using the Same,” filed in the Korean Intellectual Property Office on Feb. 27, 2006 and assigned Serial No. 2006-18760, the contents of which are incorporated herein by reference as if entirely set forth herein.

### BACKGROUND OF THE INVENTION

1. Field of the Invention

The present invention generally relates to a light receiving or light emitting optical active device, and in particular, to an optical active device in the form of a waveguide.

2. Description of the Related Art

If a laser diode used in a transmitter and a photodiode used in a receiver are packed using a surface emitting or a vertically-illuminated device instead of an edge emitting or a side-illuminated device, the laser diode can be combined with a passive device like an optical waveguide by a reflecting object having a tilt angle of 45°.

FIG. 1 illustrates a conventional optical active device of a vertical section emitting type. The optical active device of FIG. 1 includes a substrate 120, an active layer 110 formed on the substrate 120 for at least one of generating and receiving light, and a metal electrode layer 130 positioned on the substrate 120 opposite to and symmetrically with respect to the active layer 110.

The conventional optical device of one of a vertical section emitting and a vertical section receiving type has a smaller thickness t than a width A when compared to an optical active device of an edge emitting type.

However, the conventional optical active device must be combined with a passive device, such as an optical waveguide using a structure having a predetermined tilt angle and a reflecting object that is inclined with respect to an optical axis, or must include a separate sub mount, making its structure complex and increasing its volume.

### SUMMARY OF THE INVENTION

The present invention provides an optical active device that can be arranged with respect to or combined with an optical axis without the need of a separate structure.

According to one aspect of the present invention, there is provided an optical active device that includes a first face through which light is received and emitted, a second face facing the first face, a third face adjacent to the first face and the second face and a fourth face facing the third face, in which a width between the first face and the second face is equal to or greater than a distance between the third face and the fourth face.

According to another aspect of the present invention, an optical active device is applicable to a miniaturized structure as it forms the boundary face a the boundary between faces, in which it applies the electrode-formed structure to the boundary face, thus possible to arrange the optical axis using the boundary face without an additional structure. For example, the conventional optical device of a vertical section emitting or vertical section receiving type has to include a separate arrangement means, such as the sub mount, in order to combine with different optical device or an optical waveguide. Accordingly, the teachings of the present invention provides improved stability and reliability of a product by minimizing the error that can be generated on the optical axis arrangement, since the optical device does not use the additional structure, such as submount, for the optical axis arrangement.

### BRIEF DESCRIPTION OF THE DRAWINGS

The above features and advantages of the present invention become more apparent from the following detailed description when taken in conjunction with the accompanying drawings in which:

FIG. illustrates a conventional optical active device of a vertical section emitting and receiving type;

FIG. 2 illustrates an optical active device according to a first embodiment of the present invention;

FIG. 3 illustrates an optical active device according to a second embodiment of the present invention;

FIG. 5 illustrates an optical active device according to a third embodiment of the present invention;

5 illustrates an optical active device according to a fourth embodiment of the present invention;

FIG. 6A illustrates an optical module including optical active device according to the first and second embodiments of the present invention;

FIG. 6B illustrates electrical connection of an optical active device according to the first embodiment of the present invention to the device illustrated in FIG. 6A;

FIG. 6C illustrates electrical connection of an optical active device according to the second embodiment of the present invention to the device illustrated in FIG. 6A;

FIG. 7A illustrate an optical module including optical active devices according to the third and fourth embodiments of the present invention;

FIG. 7B illustrates electrical connection of an optical active device according to the third embodiment of the present invention to the device of FIG. 7A;

FIG. 7C illustrates electrical connection of an optical active device according to the fourth embodiment of the present invention to the device of FIG. 7A;

FIG. 8A illustrates an optical module including optical active device according to the second and fourth embodiments of the present invention;

FIG. 8B illustrates electrical connection of an optical active device according to the second embodiment of the present invention to the device of FIG. 8A; and

FIG. 8C illustrates electrical connection of an optical active device according to the fourth embodiment of the present invention to the device of FIG. 8A.

### DETAILED DESCRIPTION OF THE INVENTION

Exemplary embodiments of the present invention are now described in detail with reference to the annexed drawings. For the purposes of clarity and simplicity, a detailed description of known functions and configurations incorporated herein has been omitted for conciseness.

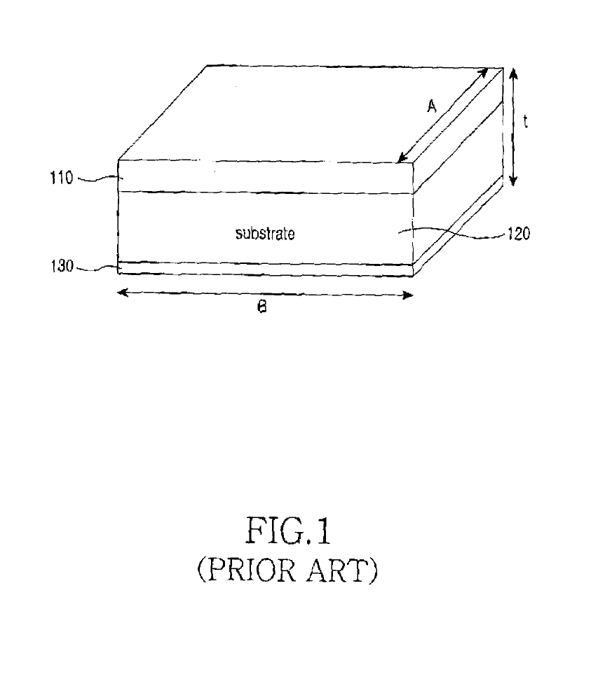

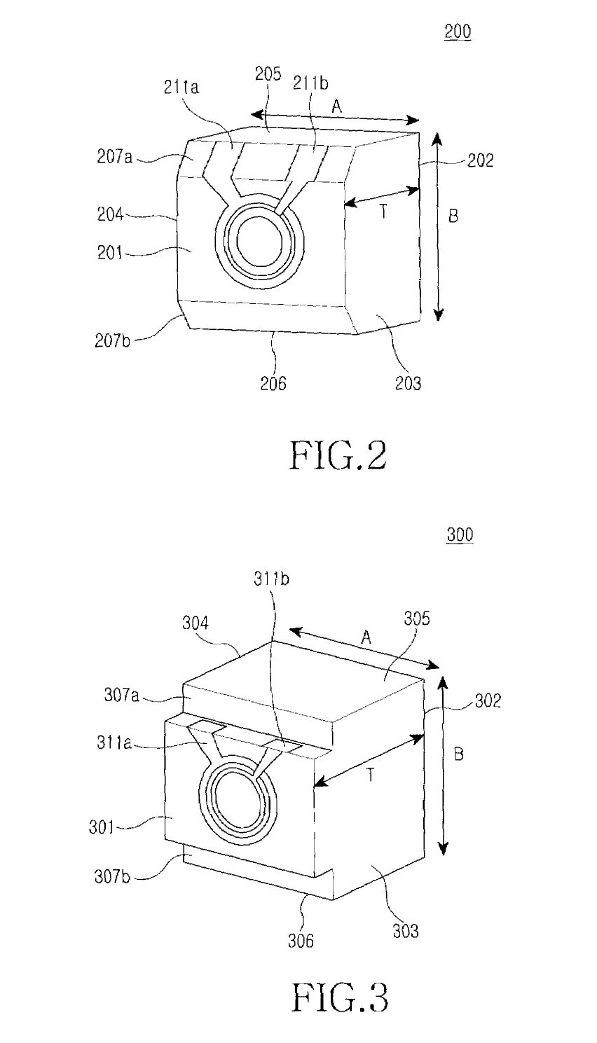

FIG. 2 illustrates an optical active device 200 according to a first embodiment of the present invention. Referring to FIG. 2, the optical active device 200 is a hexahedron using a first face 201 through which light is incident or emitted, a second face 202 facing the first face 201, a third face 203 adjacent to the first face 201 and the second face 202, a fourth face 204 facing the third face 203, and a fifth face 205 and a sixth face 206 between the first face 201 and the second face 202. A width T between the first face 201 and the second face 202 is equal to or greater than a distance A between the third face 203 and the fourth face 204, i.e., T≧A

In other words, the optical active device 200 has a miniaturized structure in which a distance B between the fifth face 205 and the sixth face 206 and the distance A between the third face 203 and the fourth face 204 are equal to or smaller than the width T between the first face 201 and the second face 202, thereby facilitating arrangement with respect to an optical axis and optical connection. In addition, slopes 207a and 207b are formed at boundaries between the first face 201 and at least one of the third through sixth faces 203-206 and electrodes 211a and 211b are formed in one of the slopes 207a and 207b (in FIG. 2, 207a), thereby achieving a miniaturized structure and easy electrical connection.

FIG. 3 illustrates an optical device 300 according to a second embodiment of the present invention. Referring to FIG. 3, the optical active device 300 of a vertical section emitting or receiving type is a hexahedron including a first face 301 through which light is incident emitted, a second face 302 facing the first face 201, a third face 303 adjacent to the first face 301 and the second face 302, a fourth face 304 facing the third face 302. A width T, between the first face 301 and the second face 302, is equal to or greater than a distance A, between the third face 303 and the fourth face 304 and a distance B between the fifth face 305 and the sixth face 306, i.e., T≧A and T≧B.

Grooves 307a and 307b formed at boundaries between the first face 301 and the fifth face 305 and between the first face 301 and the sixth face 306 are preferably used for arrangement of the optical active device 300 with other devices with respect to an optical axis or for the formation of electrodes 311a and 311b.

FIG. 4 illustrates an optical active device 400 according to a third embodiment of the present invention Referring to FIG. 4, the optical active device 400 is hexahedron including a first face 401 through which light is incident or emitted, a second face 402 facing the first face 401, a third face 403 adjacent to the first face 401 and the second face 402, a fourth face 404 facing the third face 403, and a fifth face 405 and a sixth face 406 between the first face 401 and the second face 402. A width T between the first face 401 and the second face 402 is equal to or greater than a distance A between the third face 403 and the fourth face 404 and a distance B between the fifth face 405 and the sixth face 406, i.e., T≧A and T≧B

The optical active device 400 includes slopes 407a and 407b having a predetermined tilt angle at boundaries between the first face 401 and the fifth face 405 and the first face 401 and the sixth face 406, a slope 407c at a boundary between the fifth face 405 and the second face 402, and a slope 407d at a boundary between the third face 403 and the second face 402. An electrode 411 is formed in each pair of one of the pair of slopes selected from the group of pairs of slopes consisting of 407a and 407c, the slopes 407a and 407d, and the slopes 407b and the slope 407d.

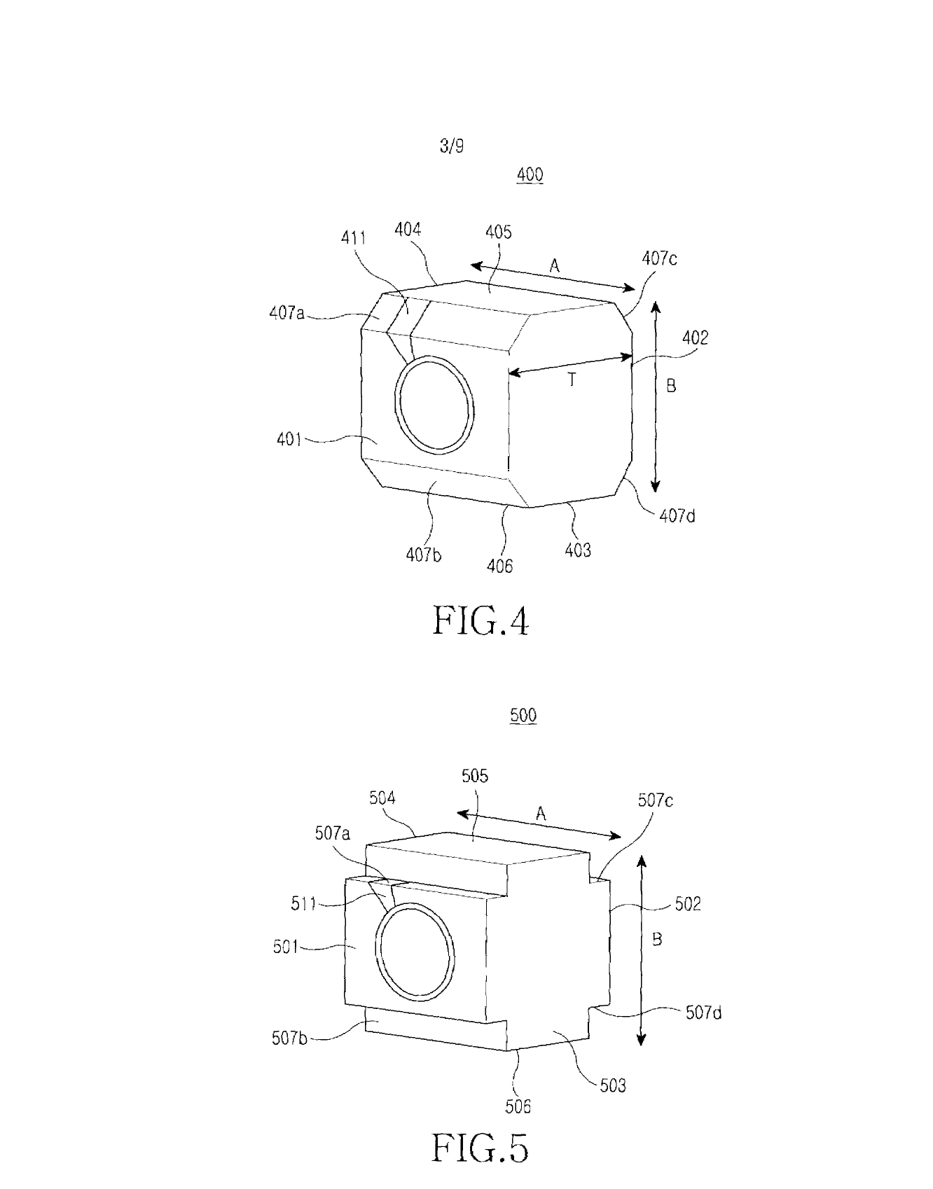

FIG. 5 illustrates an optical active device 500 according to a fourth embodiment of the present invention. Referring to FIG. 5, the optical active device 500 is a hexahedron including a first face 501 through which light is incident or emitted, a second face 502 facing the first face 501, a third face 503 adjacent to the first face 501 and the second face 502, a fourth face 504 facing the third face 503, and a fifth face 505 and a sixth face 506 between the first face 501 and the second face 502. A width, T between the first face 501 and the second face 502, is equal to or greater than a distance A, between the third face 503 and the fourth face 504 and a distance B between the fifth face 505 and the sixth face 506, i.e, T≧A and T≧B

The optical active device 500 includes grooves 507a, 507b, 507c, and 507d at boundaries between the first face 501 and the fifth face 505 and the first face 501 and the sixth face 506 and boundaries between the second face 502 and the fifth face 505 and the second face 502 and the sixth face 506, and the grooves 507a, 507b, 507c, and 507d are preferably used for arrangement with respect to one of an optical axis and the formation of an electrode 511

In the present invention, a thickness T from a light receiving or emitting face is equal to or greater than lengths A and B that are adjacent to each other in different directions. Moreover, to secure a space for the formation of an electrode before cleaving of a cleaved side, the electrode is formed after V-groove etching or deep dry etching. In the first embodiment and the second embodiment of the present invention, a device is formed on a semi-insulating substrate and is positioned in a light receiving or emitting face. Thus, an electrode is formed in only one side. On the other hand, in the third embodiment and the fourth embodiment of the present invention, a first electrode is positioned in a light receiving or emitting face and a second electrode is positioned in an opposite side thereof.

The optical active device according to the present invention can be applied by adjusting the position and shape of an electrode according to an arrangement state and a substrate state.

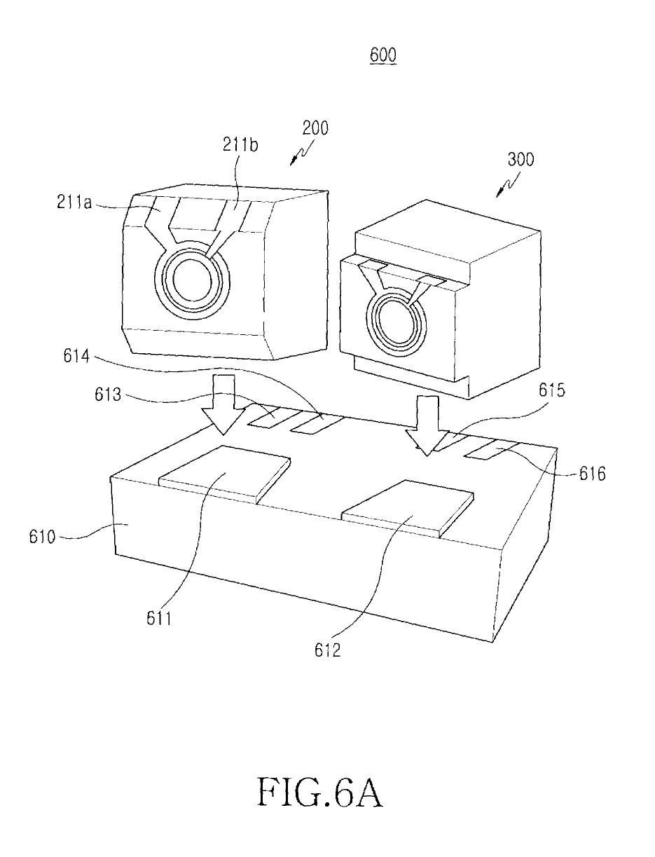

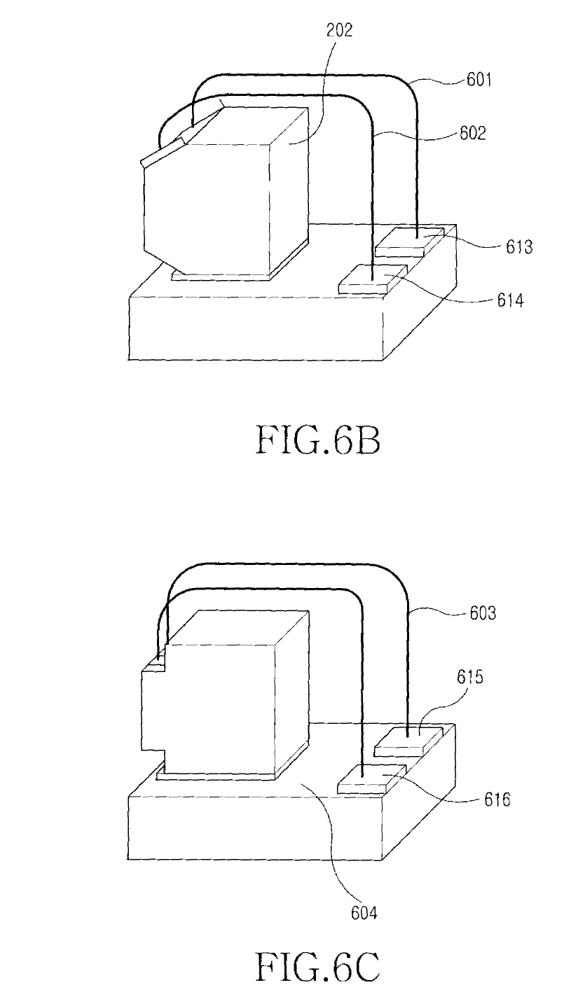

FIGS. 6A through 6C illustrate an optical module 600 including the optical active devices 200 and 300 according to the first and second embodiment of the present invention. Referring to FIGS. 6A through 6C, the optical module 600 has the optical active devices 200 and 300 that are electrically connected on a substrate 610.

Electric terminals 613, 614, 615, and 616 connected to electrodes of the optical active devices 200 and 300 and bonding pads 611 and 612 for bonding the optical active devices 200 and 300 are formed on the substrate 610. The bonding pads 611 and 612 are preferably formed of non-conductive epoxy. If the bonding pads 611 and 612 are formed of a conductive material, unintentional electrical connection is generated in a p-type and n-type bonding face

FIG. 6B illustrates electrical connection of the optical active device 200 according to the first embodiment of the present invention and placement thereof on the substrate 610. The electrodes of the optical active device 200 are connected to the electric terminals 613 and 614 by wires 601 and 602. FIG. 6C illustrates electrical connection of the optical active device 300 according to the second embodiment of the present invention is placed on the substrate 610. The electrodes of the optical active device 300 are connected to the electric terminals 615 and 615 by wires 603 and 604

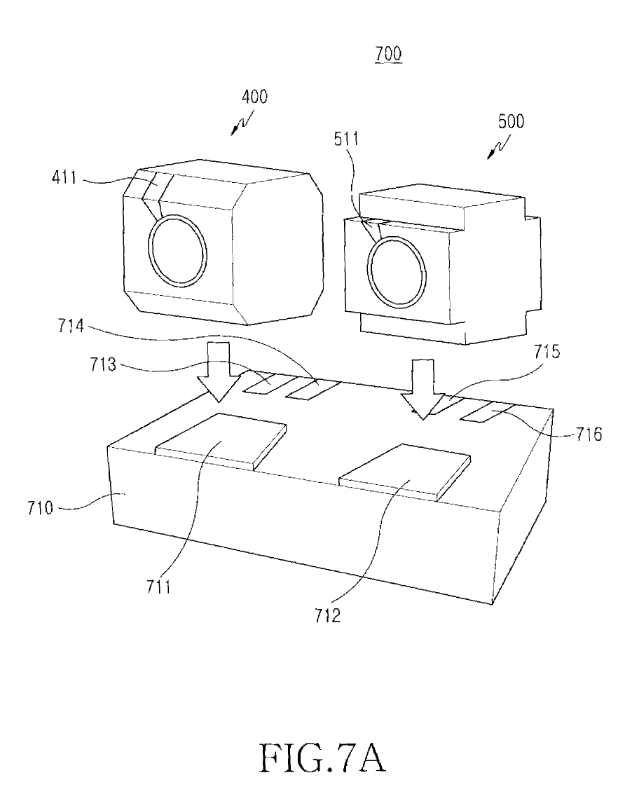

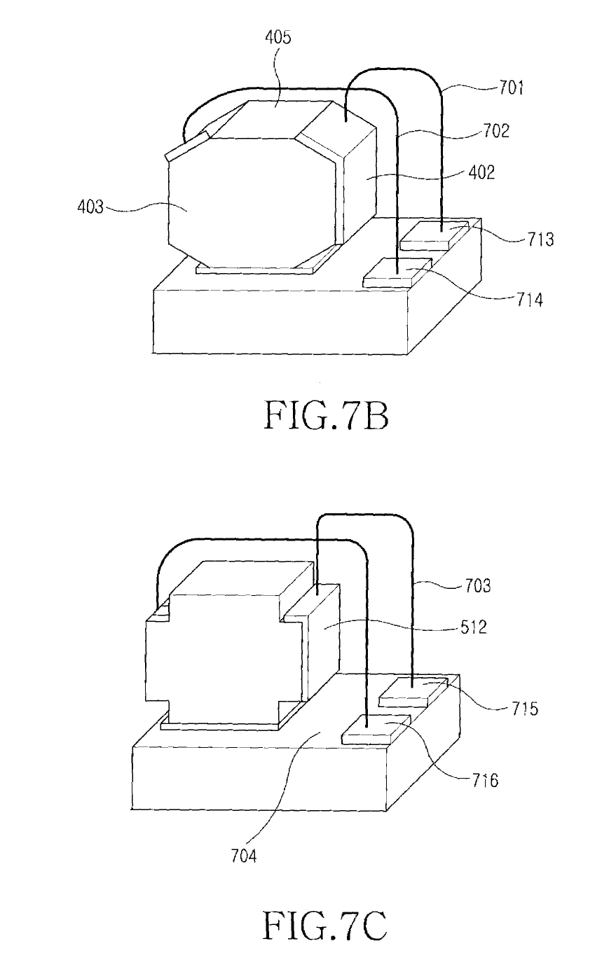

FIGS. 7A through 7C illustrate an optical module 700 including the optical actives devices 400 and 500 according to the third and fourth embodiments of the present invention. Referring to FIGS. 7A through 7C, the optical module 700 has the optical active devices 400 and 500 that are electrically connected on a substrate 710.

Electric terminals 713, 714, 715, and 716 connected to the electrodes 41 and 412 of the optical active devices 400 and 500 and bonding pads 711 and 712 for bonding the optical active devices 400 and 500 are formed on the substrate 710. The optical active devices 400 and 500 preferably use a structure comprising a semiconductor substrate or in which the electrodes 411 and 511 are formed in the first faces 401 and 501 through which light is received or emitted and the electrodes 412 and 512 are formed in the second faces 402 and 502

The electrodes, 4, 412, 511, and 512 are connected to the electric terminals 713 714, 715, and 716 by wires 701, 702, 703, and 704. Bonding pads 711 and 712 for fixing the optical active devices 400 and 500 are further formed on the substrate 710.

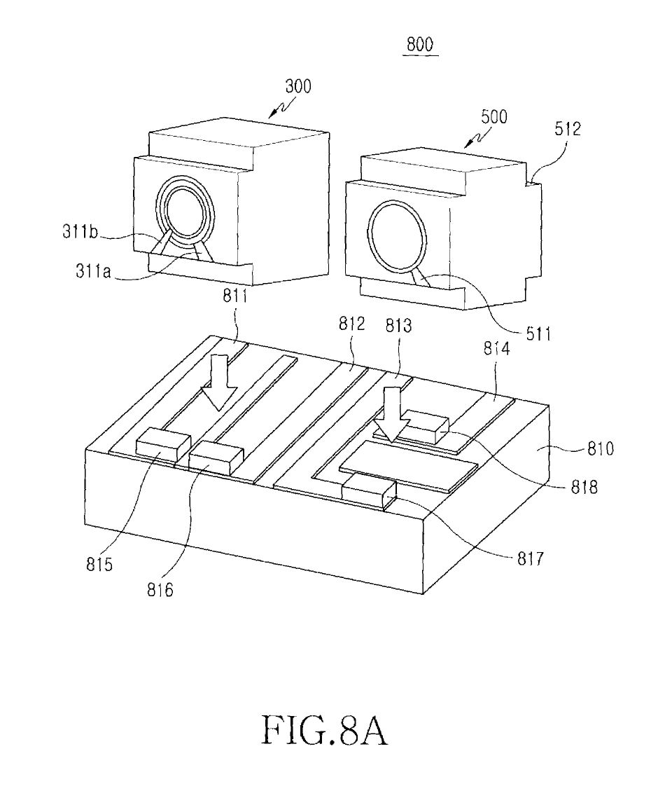

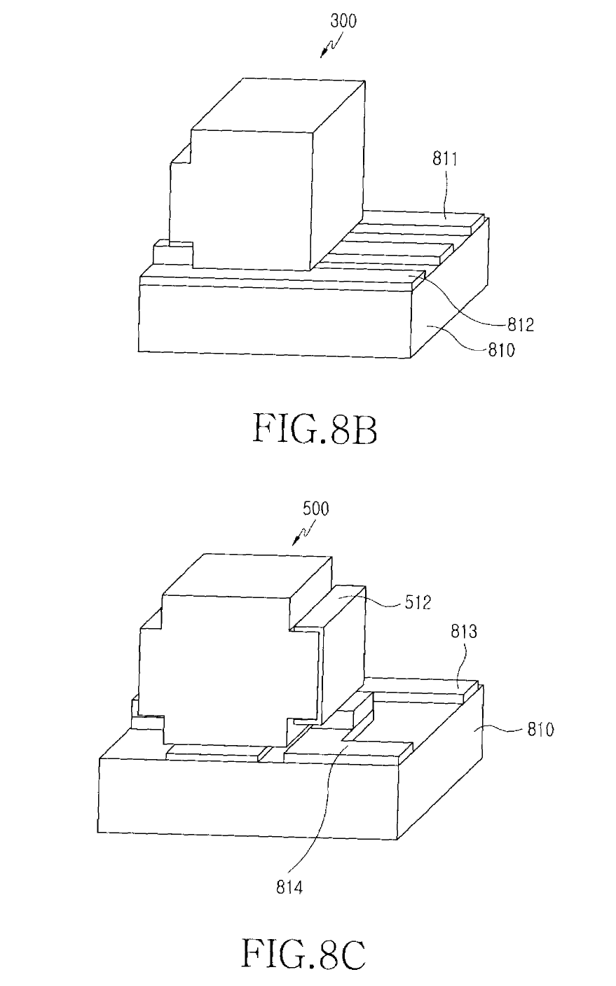

FIGS. 8A through 8C illustrate electrical connections of an optical module 800 to the optical active devices 300 and 500 according to the second and fourth embodiments of the present invention. Referring to FIGS. 8A through 8C, the optical module 800 has the optical active devices 300 and 500 that are electrically connected on a substrate 810. Electrical terminals 811, 812, 813, and 814 connected to the electrodes 311a, 311b, and 512 of the optical active devices 300 and 500 and solder bumps 815, 816, 817, and 818 for bonding the optical active devices 300 and 500 are formed on the substrate 810. The optical active device 300 according to the second embodiment of the present invention is preferably formed on a semiconductor substrate and has a structure in which the electrodes 311a and 311b are preferably formed on the first face 301 through which light is received or emitted. The optical active device 500 according to the embodiment of the present invention preferably has a structure in which the electrodes 511 and 512 are formed on the first face 501 and the second face 502, respectively.

The electrodes 311a, 311b, 511, and 512 of the optical active devices 300 and 500 are preferably directly connected to the electric terminals 811, 812, 813, and 814 by the solder bump 815, 816, 817, and 818 without using wire bonding.

According to the present invention, the optical active device is preferably arranged with respect to an optical axis without a separate structure in which a plurality of slopes of 45° are formed for optical combination thereof with other devices, thereby facilitating arrangements with respect to the optical axis and simplifying an arrangement process.

Therefore, the stability and reliability of a product can be improved and the volume and manufacturing cost of the product can be reduced.

While the present invention has been shown and described with reference to preferred embodiments thereof, it will be understood by some skilled in the art that various changes in form and details may be made therein without departing from the spirit and scope of the invention.

What is claimed is:

1. An optical active device comprising:
a first face through which light is received and emitted and a second face facing the first face;
a third face adjacent to the first face and the second face; and
a fourth face facing the third face,
wherein, a first distance between the first face and the second face is equal to or greater than a second distance between the third face and the fourth face.

2. The optical active device of claim 1, further comprising:
a fifth face and a sixth face configured between the first face and the second face, wherein the optical active device is a hexahedron in which the third through sixth faces form sides of the optical active device.

3. The optical active device of claim 2, wherein a third distance between the fifth face and the sixth face is equal to or less than the first distance between the first face and the second face.

4. The optical active device of claim 2, further comprising slopes at boundaries between the first face and at least one of the third through sixth faces.

5. The optical active device of claim 2, further comprising grooves at boundaries between the first face and at least one of the third through sixth faces.

6. The optical active device of claim 2, further comprising slopes at boundaries between the second face and at least one of the third through sixth faces.

7. The optical active device of claim 2, further comprising grooves at boundaries between the second face and at least one of the third through sixth faces.

8. The optical active device of claim 4, further comprising at least one electrode extending from the first face into the slopes.

9. The optical active device of claim 5, further comprising at least one electrode extending from the first face into the grooves.

10. An optical module comprising:
a substrate having a plurality of electric terminals formed thereon and solder bumps formed in portions of a plurality of electrodes; and
an optical device including a first face having a first plurality of electrodes thereon and through which light is received and emitted, a second face having a second plurality of electrodes thereon and configured to face the first face, a third face adjacent to the first face and the second face, a fourth face facing the third face, said first plurality of electrodes on the first face and said second plurality of electrodes on the second face are directly connected to the solder bumps.
wherein, a first distance between the first face and the second face is equal to or greater than a second distance between the third face and the fourth face.

11. A method for configuring an optical active device comprising:
providing a first face through which light is both received and emitted and a second face facing the first face said first face and said second face having a first distance therebetween;
configuring a third face adjacent to the first face and the second face and a fourth face facing the third face said third an fourth faces having a second distance therebetween such that the first distance is equal to or greater the second distance

12. The method of claim 11, further comprising the step of configuring a fifth face and a sixth face between the first face and the second face such that said optical device forms a hexahedron having the third through sixth faces as sides thereof.

13. The method of claim 12, further comprising the step of adjusting a third distance between the fifth face and the sixth face to be equal to or less than the first distance between the first face and the second face

14. The method of claim 12, further comprising the step of including slopes at boundaries between the first face and at least one of the third through sixth faces.

15. The method of claim 12, further comprising the step of including grooves at boundaries between the first face and at least one of the third through sixth faces.

16. The method of claim 12, further comprising the step of including slopes at boundaries between the second face and at least one of the third through sixth faces.

17. The method of claim 12, further comprising the step of including grooves at boundaries between the second face and at least one of the third through sixth faces.

18. The method of claim 14, further comprising the step of attaching at least one electrode extending from the first face onto the slopes.

19. The method of claim 15, further comprising the step of attaching at least one electrode extending from the first face onto the grooves.

20. A method for an optical module comprising:
providing a substrate;
forming a plurality of electric terminals and electrodes on said provided substrate;
forming solder bumps in portions of said each of said plurality of electrodes;
providing a first face having a first plurality of electrodes thereon and through which light is received and emitted, a second face having a second plurality of electrodes thereon and configured to face the first face, a third face adjacent to the first face and the second face, a fourth face facing the third face, such that said first plurality of electrodes on the first face and said second plurality of electrodes on the second face are directly connected to the solder bumps; and
adjusting a first distance between the first face and the second face to be equal to or greater than a second distance between the third face and the fourth face
